(19) United States
(12) Patent Application Publication
(10) Pub. No.: US 2026/0251473 A1
(43) Pub. Date: Aug. 27, 2026

(54) VEHICLE DISPLAY CONTROL DEVICE

(71) Applicant: TOYOTA JIDOSHA KABUSHIKI KAISHA, Toyota-shi (JP)

(72) Inventor: Miki TSUJINO, Tokyo (JP)

(73) Assignee: TOYOTA JIDOSHA KABUSHIKI KAISHA, Toyota-shi (JP)

(21) Appl. No.: 19/535,081

(22) Filed: Feb. 10, 2026

(30) Foreign Application Priority Data
Feb. 21, 2025 (JP) 2025-027343

(51) Int. Cl. G01C 21/00; B60W 30/18; B60W 50/14

(52) U.S. Cl. CPC G01C 21/3807; B60W 30/18163; B60W 50/14; B60W 2050/146; B60W 2552/10; B60W 2554/4041

(57) ABSTRACT

A vehicle display control device includes a detection unit and a display controller. The detection unit is configured to detect, when a driving assistance function of a vehicle is active, an instruction to change a lane of the vehicle, and the display controller is configured to, when the detection unit detects the instruction to change the lane, on a display region provided in the vehicle, display a path image indicating a lane change path of the vehicle from a traveling lane on which the vehicle travels to a target lane to which a lane change is made, and display the path image with a mode of the path image changed based on an end point of the path image indicating an end of the lane change path.

### CROSS-REFERENCE TO RELATED APPLICATION

This application claims priority to Japanese Patent Application No. 2025-027343 filed on February 21, 2025. The disclosure of the above-identified application, including the specification, drawings, and claims, is incorporated by reference herein in its entirety.

### BACKGROUND

### 1. Technical Field

The disclosed technology relates to a vehicle display control device.

### 2. Description of Related Art

Japanese Unexamined Patent Application Publication No. 2024-079068 (JP 2024-079068 A) discloses a vehicle control device that can execute a lane change assist control of a vehicle over a plurality of lanes even after the start of the lane change assist control without an occupant operating an operating member. The vehicle control device includes a controller that executes the lane change assist control on the vehicle when the operating member operable by the occupant of the vehicle is operated. The controller executes a first lane change assist control of moving the vehicle from a traveling lane that is a lane on which the vehicle is traveling to an adjacent lane when a first operation is executed on the operating member. The controller executes a second lane change assist control of moving the vehicle from the traveling lane to a spaced lane that is a lane on a side opposite to the traveling lane across the adjacent lane when a second operation different from the first operation is executed on the operating member.

### SUMMARY

In the vehicle control device described in JP 2024-079068 A, when the occupant executes a lane change assist (LCA) control, a traveling trajectory image indicating a path of a lane change is displayed on a display around a driver's seat. The traveling trajectory image is displayed while the LCA is being executed, but there is room for improvement in displaying, in a manner easy for the occupant to understand, a range in which the control by the LCA is executed on the path of the lane change.

An object of the disclosed technology is to provide a vehicle display control device that can increase a sense of security of an occupant by displaying, in a manner easy for the occupant to understand, a control range of a driving assistance function during a lane change.

A vehicle display control device according to a first aspect includes a detection unit configured to detect, when a driving assistance function of a vehicle is active, an instruction to change a lane of the vehicle, and

a display controller configured to, when the detection unit detects the instruction to change the lane, on a display region provided in the vehicle, display a path image indicating a lane change path of the vehicle from a traveling lane on which the vehicle travels to a target lane to which a lane change is made, and display the path image with a mode of the path image changed based on an end point of the path image indicating an end of the lane change path. With the vehicle display control device according to the first aspect, it is possible to increase a sense of security of an occupant by displaying, in a manner easy for the occupant to understand, a control range of a driving assistance function during the lane change.

In a vehicle display control device according to a second aspect, in the vehicle display control device according to the first aspect,

the display controller is configured to change a display mode of the path image by using, as a start point, a position located a predetermined amount toward a start point side from the end point of the path image. With the vehicle display control device according to the second aspect, it is possible to improve predictability of a driving operation of the occupant by displaying that, in a manner easy for the occupant to understand, a control by the driving assistance function during the lane change is ended.

In a vehicle display control device according to a third aspect, in the vehicle display control device according to the second aspect,

the display controller is configured to display the path image with a gradient from the start point to the end point. With the vehicle display control device according to the third aspect, it is possible to cause the occupant to intuitively understand that the control by the driving assistance function during the lane change is ended.

In a vehicle display control device according to a fourth aspect, in the vehicle display control device according to any one of the first aspect to the third aspect,

the detection unit is configured to detect, as the instruction to change the lane, an instruction to overtake a preceding vehicle traveling ahead of the vehicle and

the display controller is configured to display, as the path image, a first path image indicating a lane change path when a lane change is made from the traveling lane to the target lane at a position rearward of the preceding vehicle, and a second path image indicating a lane change path when a lane change is made from the traveling lane after the lane change to the target lane at a position frontward of the preceding vehicle. With the vehicle display control device according to the fourth aspect, it is possible to increase a sense of security of the occupant by displaying, in a manner easy for the occupant to understand, the control range of the driving assistance function according to the lane change for overtaking.

With the disclosed technology, it is possible to increase a sense of security of an occupant by displaying, in a manner easy for the occupant to understand, a control range of a driving assistance function during the lane change.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a hardware configuration of a vehicle display control device according to a first embodiment;

FIG. 2 is a block diagram showing a functional configuration of the vehicle display control device according to the first embodiment;

FIG. 3A is an example of a display screen according to the first embodiment;

FIG. 3B is an example of a display screen according to the first embodiment;

FIG. 3C is an example of a display screen according to the first embodiment;

FIG. 4 is a flowchart showing an example of a flow of a display process according to the first embodiment;

FIG. 5 is an example of a display screen according to a second embodiment; and

FIG. 6 is a flowchart showing an example of a flow of a display process according to the second embodiment.

### DETAILED DESCRIPTION OF EMBODIMENTS

### First Embodiment

A vehicle display control device 10 mounted on a vehicle (hereinafter, also referred to as a host vehicle) according to the present embodiment will be described with reference to the drawings.

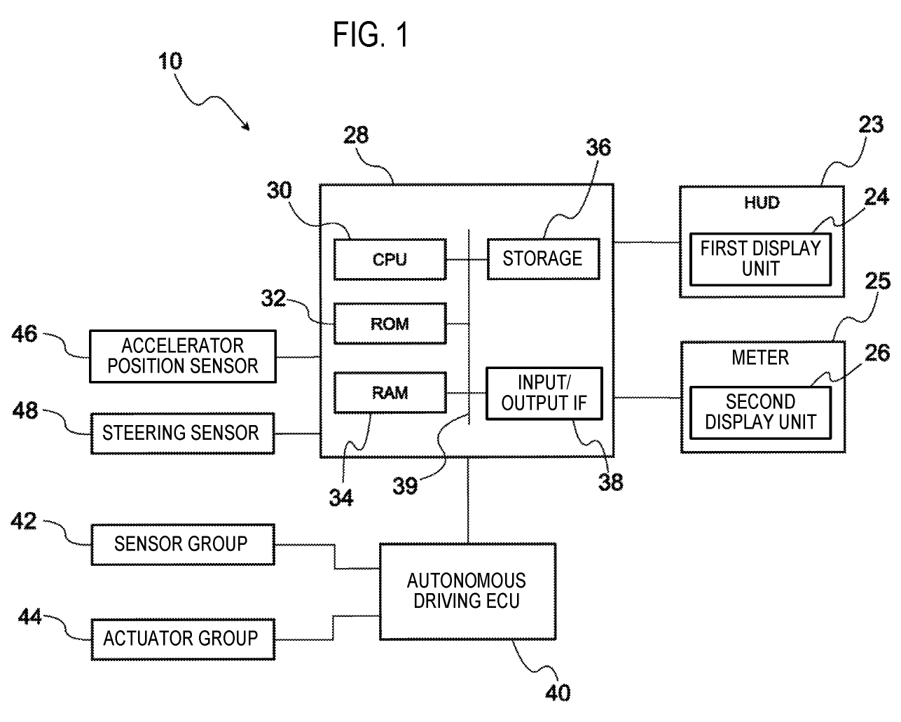

As shown in FIG. 1, the vehicle display control device 10 according to the first embodiment is configured to include an electronic control unit (ECU) 28.

The ECU 28 is configured to include a central processing unit (CPU) 30, a read only memory (ROM) 32, a random access memory (RAM) 34, a storage 36, and an input/output interface 38. Each configuration is connected to communicate with each other via an internal bus 39.

The CPU 30 is a central processing unit that executes various programs or controls each unit. That is, the CPU 30 reads a program from the ROM 32 or the storage 36 and executes the program using the RAM 34 as a work area. In addition, the CPU 30 controls each configuration and performs various arithmetic processes according to the program recorded in the ROM 32 or the storage 36.

The ROM 32 stores various programs and various data. The RAM 34 temporarily stores a program or data as a work area. The storage 36 is a non-transitory recording medium that is configured by a hard disk drive (HDD) or a solid state drive (SSD) and stores various programs including an operating system and various data. In the present embodiment, the ROM 32 or the storage 36 stores a display program or the like for performing a display process. In addition, various input/output devices are connected to the input/output interface 38.

Here, the ECU 28 is electrically connected to an autonomous driving ECU 40. The autonomous driving ECU 40 is configured to include a CPU, a ROM, a RAM, a storage, an input/output interface, and the like (not shown), similarly to the ECU 28.

A sensor group 42 that detects a current situation of the vehicle and an actuator group 44 that controls traveling of the vehicle are connected to the autonomous driving ECU 40. The sensor group 42 includes a plurality of sensors among various sensors such as a camera, a radar, a light detection and ranging (LIDAR) or laser imaging detection and ranging (LIDAR), and a global positioning system (GPS) sensor. The camera images a periphery of the vehicle. The radar detects a distance and a direction to an object in the periphery of the vehicle by radio waves. The LIDAR detects a distance and a direction to an object in the periphery of the vehicle by laser light. The GPS sensor detects a current position of the vehicle. In addition, the sensor group 42 is configured to include a sensor that detects a state of the occupant. For example, the sensor group 42 may be configured to include a biological sensor that detects a heart rate, and an alertness level of the occupant.

The actuator group 44 includes an acceleration/deceleration actuator that adjusts acceleration and deceleration of the vehicle and a steering actuator that drives a steering device of the vehicle. The autonomous driving ECU 40 performs autonomous driving of the vehicle by controlling an operation of the actuator group 44 according to the current situation of the vehicle detected by the sensor group 42. It should be noted that a scheduled path representing a path on which the vehicle is scheduled to travel is stored in a storage unit of the autonomous driving ECU 40, and the autonomous driving ECU 40 causes the vehicle to travel along the scheduled path stored in the storage unit.

A head-up display device 23 and a meter 25 are connected to the ECU 28. A first display unit 24 is configured by a projection surface projected by the head-up display device 23. In addition, a second display unit 26 is a display unit displayed on the meter 25, and the meter 25 is positioned in front of a driver's seat in an instrument panel (not shown) provided in a front portion of a vehicle cabin of the vehicle. The first display unit 24 and the second display unit 26 are provided at positions visible to the driver. The first display unit 24 and the second display unit 26 are examples of a "display region provided in the vehicle".

An accelerator position sensor 46 and a steering sensor 48 are connected to the ECU 28. The accelerator position sensor 46 is a sensor that detects a position of an accelerator pedal (not shown) provided below the driver's seat. In addition, the steering sensor 48 is a sensor that detects a load applied to a steering wheel 16 by the occupant. That is, the steering sensor 48 according to the present embodiment is configured to detect the load when the occupant operates the steering wheel 16 and not to detect the load when the steering wheel 16 is operated by the autonomous driving ECU 40 during autonomous driving.

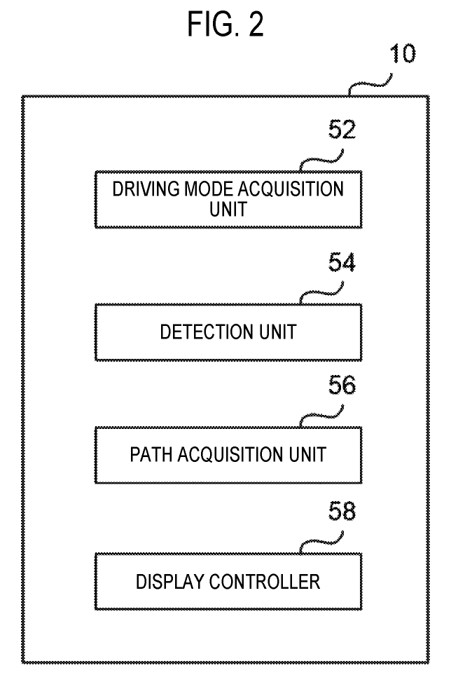

The vehicle display control device 10 implements various functions by using the hardware resources. A functional configuration of the vehicle display control device 10 will be described with reference to FIG. 2.

As shown in FIG. 2, the vehicle display control device 10 is configured to include a driving mode acquisition unit 52, a detection unit 54, a path acquisition unit 56, and a display controller 58 as a functional configuration. Each functional configuration is implemented by the CPU 30 of the ECU 28 reading out and executing a program.

The driving mode acquisition unit 52 acquires which of driving mode of a manual driving mode and an autonomous driving mode is a driving mode of the vehicle. Here, the manual driving mode according to the present embodiment refers to a driving mode in which the vehicle travels via the driving operation of the occupant. In addition, the autonomous driving mode according to the present embodiment refers to a driving mode in which the vehicle travels without the accelerator operation of the occupant. The autonomous driving mode according to the present embodiment refers to, for example, a case where an adaptive cruise control (ACC) is operating. The ACC is a driving assistance function that recognizes a preceding vehicle with a camera and a radar (a monocular camera and a millimeter wave radar) included in the sensor group 42 and supports following traveling while a vehicle-to-vehicle distance is maintained according to a vehicle speed. The driving mode acquisition unit 52 acquires information on the driving mode based on, for example, a signal from the autonomous driving ECU 40. In addition, the autonomous driving mode may refer to a case where an advanced drive (AD) is operating. The AD is an advanced driving assistance function that performs steering and acceleration/deceleration control under driver monitoring on a motorway (hands-off autonomous driving Lv2 is possible).

The detection unit 54 has a function of detecting an operation instruction of the driving assistance function. Specifically, the detection unit 54 detects an operation instruction of a lane change assist (LCA) control. Here, the LCA is a driving assistance function that is started by a turn signal operation of the occupant. In addition, the LCA performs steering support and peripheral monitoring support during the lane change and automatically turns off the turn signal after the lane change. The detection unit 54 detects the operation instruction of the LCA based on, for example, a signal from the autonomous driving ECU 40.

The path acquisition unit 56 has a function of acquiring a lane change path of the vehicle. Specifically, the path acquisition unit 56 acquires the lane change path of the vehicle when the lane change is performed by the LCA that is analyzed by the autonomous driving ECU 40. Here, the autonomous driving ECU 40 determines the lane change path of the vehicle according to the vehicle speed of the vehicle, the presence or absence of an obstacle in the periphery, the recognition range, and the like.

The display controller 58 displays peripheral information of the vehicle on the first display unit 24 and the second display unit 26 provided in the vehicle cabin. Specifically, the display controller 58 acquires a signal from the sensor group 42 and displays the peripheral information of the vehicle on the first display unit 24 and the second display unit 26 based on the acquired signal.

In addition, when the driving mode acquired by the driving mode acquisition unit 52 is the autonomous driving mode and the operation instruction of the LCA is detected, the display controller 58 displays a trajectory image that is an image indicating the lane change path by the LCA on the first display unit 24 and the second display unit 26. Specifically, the display controller 58 displays the trajectory image at a position corresponding to the path acquired by the path acquisition unit 56 on a display region of the first display unit 24 and the second display unit 26. The trajectory image is an example of a "path image".

The display controller 58 has a function of changing and displaying an aspect of the trajectory image based on an end point (hereinafter, also referred to as an end point) of the trajectory image indicating a position of an end point of the lane change path. For example, the display controller 58 performs a gradation display from the end point of the trajectory image to a position in front of the start point side by a predetermined amount. Here, the start point of the trajectory image is a position indicating a start point of the lane change path. The start point of the trajectory image according to the present embodiment matches a position where a host vehicle image M1 to be described later is displayed. The start point of the trajectory image is, for example, a position where rear wheels of the host vehicle image M1 are displayed.

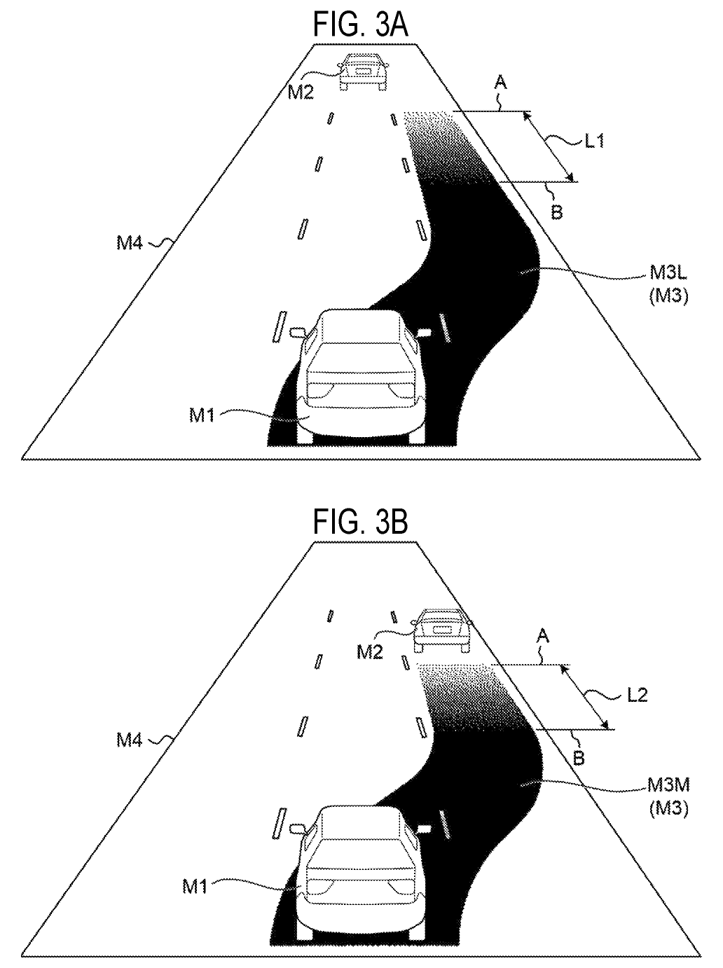

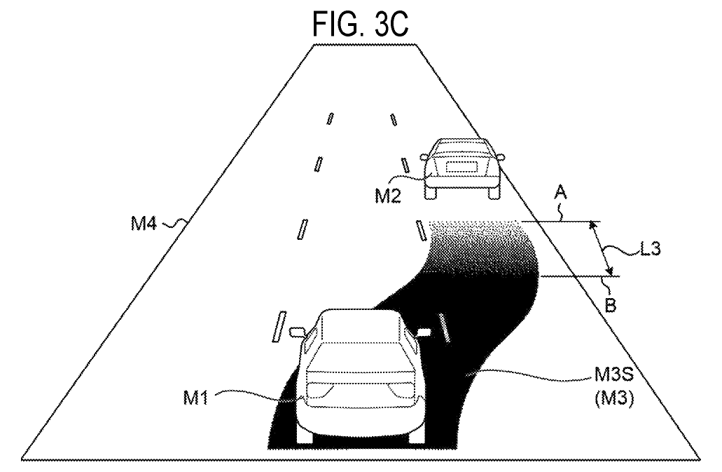

Next, a part of a display screen of the second display unit 26 when the ACC is active will be described with reference to FIGS. 3A, 3B and 3C. In the present embodiment, a case where the vehicle changes the lane to the adjacent lane on the right side from a lane on which the vehicle travels (hereinafter, also referred to as a traveling lane) by the LCA will be described as an example. It should be noted that the front-rear direction refers to a front-rear direction with respect to a straight-ahead direction of the vehicle, and matches an up-down direction of the second display unit 26. In addition, the left-right direction refers to a left-right direction of the vehicle, and matches a left-right direction of the second display unit 26. The adjacent lane on the right side is an example of a "target lane".

As shown in FIG. 3A, the second display unit 26 displays a host vehicle image M1, a vehicle image M2 of another vehicle, a trajectory image M3L, and a lane image M4. The trajectory image M3 according to the present embodiment includes the trajectory image M3L, a trajectory image M3M (see FIG. 3B), and a trajectory image M3S (see FIG. 3C). In addition, the lane image M4 is an image that simulates the traveling lane and the adjacent lane of the traveling lane.

The host vehicle image M1 is an image that simulates the vehicle. The host vehicle image M1 is displayed to be superimposed on the trajectory image M3 and the lane image M4 in a lower portion of the display region of the second display unit 26. The host vehicle image M1 shown in FIG. 3A is displayed as an image showing a passenger car at a position indicating the traveling lane.

The vehicle image M2 of another vehicle is an image that simulates another vehicle that is present in the periphery of the vehicle. The vehicle image M2 of another vehicle is displayed to be superimposed on the lane image M4 by changing a display position and a size according to a relative positional relationship between the vehicle and the other vehicle. The vehicle image M2 of another vehicle shown in FIG. 3A is displayed as an image showing a passenger car at a position indicating a location on the traveling lane that is about 100 m at a position frontward of the vehicle. It should be noted that the other vehicle includes a four-wheeled vehicle, a two-wheeled vehicle, and the like.

The trajectory image M3 is an image showing the lane change path of the vehicle. The trajectory image M3 is displayed to be superimposed on the lane image M4. The trajectory image M3 according to the present embodiment is displayed as a green band-shaped image extending from a position where the host vehicle image M1 is displayed to a position indicating an end point of the lane change path. In addition, a width of the trajectory image M3 is displayed to be narrower than a width of one lane shown in the lane image M4.

In addition, the trajectory image M3 is displayed by performing a gradation process such that a transparency gradually increases to a position indicating the end point of the lane change path. The gradation process on the trajectory image M3 is applied from a position in front of the position indicating the end point of the lane change path by a predetermined amount according to a length of the trajectory image M3. It should be noted that the trajectory image M3 may be displayed by changing the aspect by a change in color, a change in shape, an animation, or the like in addition to the gradation of the transparency.

The trajectory image M3L shown in FIG. 3A is a trajectory image displayed when a length of the acquired lane change path is 80 m. In addition, a portion of the trajectory image M3L corresponding to a distance L1 indicating an interval between a dimension line A and a dimension line B is displayed in a gradation. The gradation of the trajectory image M3L is a gradation in which the trajectory image M3L is gradually not displayed from a position indicated by the dimension line B to a position indicated by the dimension line A. The position indicated by the dimension line A is a position indicating the end point of the lane change path. In addition, the position indicated by the dimension line B is a position indicating a position in front of the start point side by a predetermined distance from the end point of the lane change path. The position indicated by the dimension line B is, for example, a position indicating a position 20 m in front of the end point of the lane change path.

As described above, by displaying the trajectory image M3L, the path when the vehicle changes the lane by the LCA is displayed. In addition, by performing the gradation process on the trajectory image M3L and displaying the trajectory image M3L, the occupant can intuitively understand that the control by the LCA is ended.

As shown in FIG. 3B, the second display unit 26 displays the host vehicle image M1, the vehicle image M2 of another vehicle, a trajectory image M3M, and the lane image M4. Since the host vehicle image M1 and the lane image M4 are the same as in FIG. 3A, detailed descriptions thereof will be omitted.

The vehicle image M2 of another vehicle shown in FIG. 3B is displayed as an image showing a passenger car at a position indicating a location on the adjacent lane on the right side of the traveling lane that is about 70 m at a position frontward of the vehicle.

The trajectory image M3M is a trajectory image displayed when a length of the acquired lane change path is 60 m. The trajectory image M3M is displayed to be shorter than the trajectory image M3L (see FIG. 3A). In addition, the trajectory image M3M is displayed in front of the vehicle image M2 of another vehicle. The trajectory image M3M is displayed in a gradation in a portion corresponding to a distance L2 indicating an interval between the dimension line A and the dimension line B. The position indicated by the dimension line B shown in FIG. 3B is, for example, a position indicating a position 15 m in front of the end point of the lane change path.

As described above, by displaying the trajectory image M3M to be shorter than the trajectory image M3L, it is indicated that the section controlled by the LCA is shorter than in the case of FIG. 3A. In addition, by performing the gradation process on the trajectory image M3M and displaying the trajectory image M3M in front of the vehicle image M2 of another vehicle, it is indicated that the control by the LCA is ended as the vehicle approaches the other vehicle shown in the vehicle image M2 of another vehicle.

As shown in FIG. 3C, the second display unit 26 displays the host vehicle image M1, the vehicle image M2 of another vehicle, a trajectory image M3S, and the lane image M4. Since the host vehicle image M1 and the lane image M4 are the same as in FIG. 3A, detailed descriptions thereof will be omitted.

The vehicle image M2 of another vehicle shown in FIG. 3C is displayed as an image showing a passenger car at a position indicating a location on the adjacent lane to which the vehicle changes the lane that is about 50 m at a position frontward of the vehicle.

The trajectory image M3S is a trajectory image displayed when a length of the acquired lane change path is 40 m. The trajectory image M3S is displayed to be shorter than the trajectory image M3M (see FIG. 3B). In addition, the trajectory image M3S is displayed in front of the vehicle image M2 of another vehicle. The trajectory image M3S is displayed in a gradation in a portion corresponding to a distance L3 indicating an interval between the dimension line A and the dimension line B. The position indicated by the dimension line B shown in FIG. 3C is, for example, a position indicating a position 10 m in front of the end point of the lane change path.

As described above, by displaying the trajectory image M3S to be shorter than the trajectory image M3M, it is indicated that the section controlled by the LCA is shorter than in the case of FIG. 3B. In addition, by performing the gradation process on the trajectory image M3S and displaying the trajectory image M3S in front of the vehicle image M2 of another vehicle, it is indicated that the control by the LCA is ended as the vehicle approaches the other vehicle shown in the vehicle image M2 of another vehicle.

As shown in FIGS. 3A to 3C, by changing and displaying the distance on which the gradation process is performed according to the length of the lane change path, it is possible to reduce a sense of discomfort given to the occupant when the lengths of the lane change paths are different. In addition, by performing the gradation process on the trajectory image M3 and displaying the trajectory image M3 from a position in front of the start point side by a predetermined amount from the end point of the trajectory image M3, the occupant can easily understand that the control by the LCA is ended, and thus the predictability of the driving operation of the occupant can be improved. It should be noted that, in the screen example, the cases where the length of the lane change path is 80 m, 60 m, and 40 m have been described, but the length of the lane change path is not limited thereto. The position of the start point of the trajectory image M3 may be changed according to the length of the acquired lane change path.

It should be noted that, in the description of FIGS. 3A to 3C, an example of the display screen of the second display unit 26 has been described, but in the present embodiment, the display screen may be configured to be displayed on at least one of the first display unit 24 or the second display unit 26. In addition, when the display region of the first display unit 24 is narrower than the display region of the second display unit 26, the first display unit 24 may be configured to display a part of the image of the second display unit 26 (for example, solely the trajectory image M3).

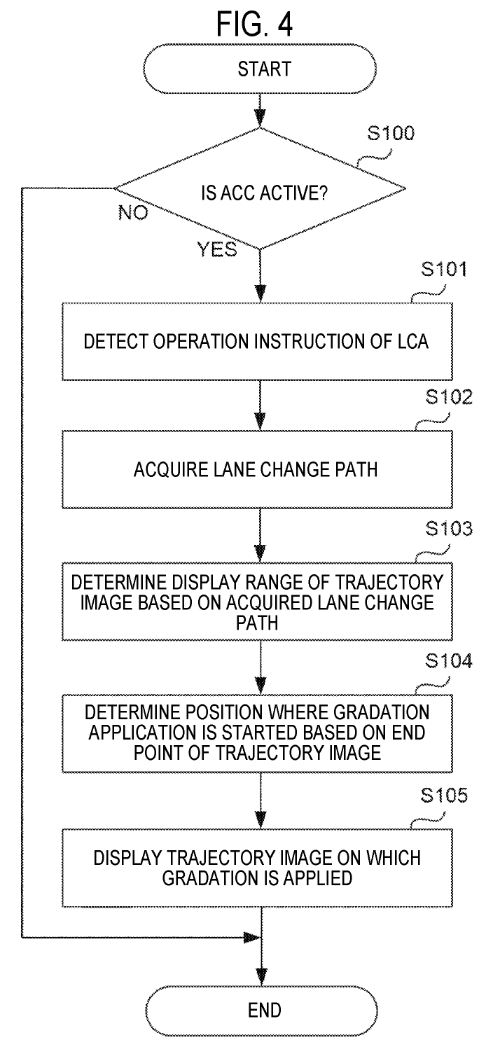

FIG. 4 is a flowchart showing an example of a flow of a display process according to the first embodiment. The display process is executed by the CPU 30 of the ECU 28 reading out a program from the ROM 32 or the storage 36, and executing the program by expanding the program in the RAM 34. For example, the display process shown in FIG. 4 is a process that is repeatedly executed while the vehicle is traveling.

In S100 of FIG. 4, the CPU 30 determines whether the ACC is active. Specifically, the CPU 30 acquires the driving mode of the vehicle and determines whether the acquired driving mode is the autonomous driving mode. When the CPU 30 determines that the ACC is active (S100: YES), the process proceeds to S101. On the other hand, when the CPU 30 determines that the ACC is not active (S100: NO), the display process is ended.

In S101, the CPU 30 detects the operation instruction of the LCA. That is, when the ACC of the vehicle is active and the operation instruction of the LCA is detected, the CPU 30 proceeds to S102 and subsequent steps.

In S102, the CPU 30 acquires the lane change path. Specifically, the CPU 30 acquires the lane change path of the vehicle from the traveling lane to the adjacent lane to which the vehicle changes the lane by the LCA that is analyzed by the autonomous driving ECU 40.

In S103, the CPU 30 determines a display range of the trajectory image M3 based on the acquired lane change path. Specifically, the CPU 30 determines coordinates indicating each of a position where the vehicle starts to turn to the adjacent lane, a position where the vehicle ends to turn to the adjacent lane, and an end point of the lane change path acquired in S102. For example, the CPU 30 determines the coordinates indicating the position 80 m in front of the vehicle in the adjacent lane to which the vehicle changes the lane as the coordinates of the end point of the lane change path.

In S104, the CPU 30 determines a position where the gradation is started based on the end point of the trajectory image M3. Specifically, the CPU 30 determines the coordinates indicating the position in front of the start point side by a predetermined amount from the coordinates indicating the position of the end point of the lane change path determined in S103 as the position where the gradation is started. For example, the CPU 30 determines the coordinates indicating the position 20 m in front of the end point of the lane change path in the adjacent lane to which the vehicle changes the lane as the coordinates where the gradation is started on the trajectory image M3. That is, the CPU 30 sets a range from the coordinates indicating the position 20 m in front of the end point of the lane change path to the coordinates indicating the end point of the lane change path as a range on which the gradation process is performed on the trajectory image M3.

In S105, the CPU 30 displays the trajectory image M3 on which the gradation is applied. Specifically, the CPU 30 displays the trajectory image M3L on which the gradation process is performed from the position where the gradation is started determined in S104 to the position indicating the end point of the lane change path on the second display unit 26 (see FIG. 3A). Then, the CPU 30 ends the display process.

It should be noted that the CPU 30 may change and display the position of the trajectory image M3 according to the traveling position of the vehicle until the control of the lane change of the vehicle by the LCA is ended. The CPU 30 may not display the trajectory image M3 when the control of the lane change by the LCA is ended.

When the ACC of the vehicle is active and the operation instruction of the LCA is detected, the vehicle display control device 10 according to the first embodiment performs the gradation process on the trajectory image M3, using as a start point, a position located a predetermined amount toward a start point side from the end point, from the start point to the end point of the trajectory image M3, and displays the trajectory image M3 on the second display unit 26. Therefore, with the vehicle display control device according to the present embodiment, the sense of security of the occupant can be increased by displaying, in a manner easy for the occupant to understand, the control range of the LCA.

### Second Embodiment

In the first embodiment, the vehicle display control device 10 displays the trajectory image M3 when the operation instruction of the LCA is detected. In the second embodiment, the vehicle display control device 10 displays a plurality of trajectory images M3 when the operation instruction of the overtaking control is detected. Hereinafter, differences from the first embodiment will be described. It should be noted that, the other configurations are the same as those of the embodiment, and detailed descriptions thereof will be omitted.

The detection unit 54 detects the operation instruction of the overtaking control. The detection unit 54 detects the operation instruction of the overtaking control based on, for example, a signal from the autonomous driving ECU 40. The overtaking control is, for example, a driving assistance function that operates when the AD is active.

The path acquisition unit 56 has a function of acquiring an overtaking path of the vehicle. Specifically, the path acquisition unit 56 acquires the path of the vehicle in a case of overtaking a vehicle to be overtaken (hereinafter, also referred to as a preceding vehicle) by the overtaking control that is analyzed by the autonomous driving ECU 40. The path acquisition unit 56 acquires a lane change path from the traveling lane at a position rearward of the preceding vehicle to the overtaking lane and a lane change path from the overtaking lane at a position frontward of the preceding vehicle to the traveling lane for returning to the traveling lane.

The display controller 58 displays the plurality of trajectory images. Specifically, the display controller 58 displays the trajectory image corresponding to each of the lane change path from the traveling lane to the overtaking lane and the lane change path from the overtaking lane to the traveling lane that are acquired by the path acquisition unit 56. It should be noted that the display controller 58 may not display the trajectory image at a position corresponding to a range between the plurality of lane change paths where the control of the lane change is not performed.

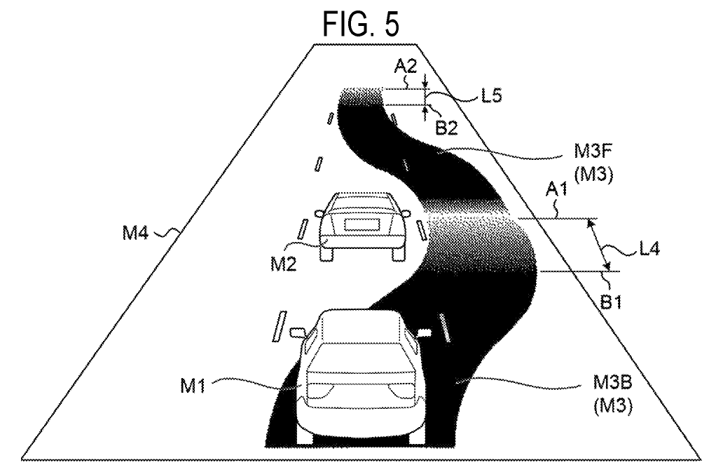

Next, a part of the display screen of the second display unit 26 when the AD is active will be described with reference to FIG. 5. In the present embodiment, a case where the vehicle changes the lane from the traveling lane to the overtaking lane by the overtaking control and changes the lane from the overtaking lane to the traveling lane will be described as an example.

As shown in FIG. 5, the second display unit 26 displays the host vehicle image M1, the vehicle image M2 of another vehicle, trajectory images M3B and M3F, and the lane image M4. Since the host vehicle image M1 and the lane image M4 are the same as in FIG. 3A, detailed descriptions thereof will be omitted.

The vehicle image M2 of another vehicle shown in FIG. 5 is an image that simulates a preceding vehicle to be overtaken. The vehicle image M2 of another vehicle is displayed as an image showing a passenger car at a position indicating a location on the traveling lane that is about 40 m at a position frontward of the vehicle, for example.

The trajectory image M3B is an image showing a lane change path for changing the lane to the overtaking lane at a position rearward of the preceding vehicle. The trajectory image M3B shown in FIG. 5 is a trajectory image displayed when the length of the lane change path for the vehicle to change the lane to the overtaking lane behind the vehicle image M2 of another vehicle is 40 m. A portion of the trajectory image M3B corresponding to a distance L4 indicating an interval between a dimension line A1 and a dimension line B1 is displayed in a gradation. The position indicated by the dimension line B1 shown in FIG. 5 is, for example, a position indicating a position 10 m in front of the end point of the lane change path. The trajectory image M3B is an example of a "first path image".

The trajectory image M3F is an image showing a lane change path for returning to the traveling lane at a position frontward of the preceding vehicle. The trajectory image M3F shown in FIG. 5 is a trajectory image displayed when the length of the lane change path for returning to the traveling lane in front of the vehicle image M2 of another vehicle is 40 m. A portion of the trajectory image M3F corresponding to a distance L5 indicating an interval between a dimension line A2 and a dimension line B2 is displayed in a gradation. The position indicated by the dimension line B2 shown in FIG. 5 is, for example, a position indicating a position 10 m in front of the end point of the lane change path. The trajectory image M3F is an example of a "second path image".

As described above, by displaying the trajectory images M3B and M3F, the control range of the lane change of the vehicle by the overtaking control is indicated.

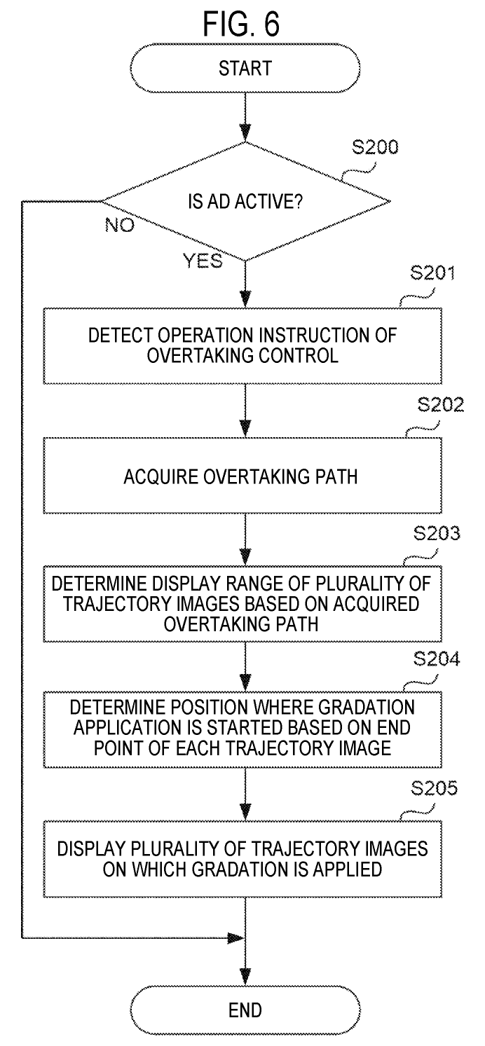

FIG. 6 is a flowchart showing an example of a flow of a display process according to the second embodiment. The display process is executed by the CPU 30 of the ECU 28 reading out a program from the ROM 32 or the storage 36, and executing the program by expanding the program in the RAM 34. For example, the display process shown in FIG. 6 is a process that is repeatedly executed while the vehicle is traveling.

In S200 of FIG. 6, the CPU 30 determines whether the AD is active. When the CPU 30 determines that the AD is active (S200: YES), the process proceeds to S201. On the other hand, when the CPU 30 determines that the AD is not active (S200: NO), the display process is ended.

In S201, the CPU 30 detects the operation instruction of the overtaking control. That is, when the AD of the vehicle is active and the operation instruction of the overtaking control is detected, the CPU 30 proceeds to S202 and subsequent steps.

In S202, the CPU 30 acquires the overtaking path. Specifically, the CPU 30 acquires the overtaking path of the vehicle by the overtaking control that is analyzed by the autonomous driving ECU 40. The CPU 30 acquires the lane change path from the traveling lane on which the vehicle travels to the adjacent lane to which the vehicle changes the lane and the lane change path for returning to the traveling lane from the adjacent lane.

In S203, the CPU 30 determines a display range of the plurality of trajectory images based on the acquired overtaking path. Specifically, the CPU 30 determines coordinates indicating each of a position where the vehicle starts to turn to the adjacent lane, a position where the vehicle ends to turn to the adjacent lane, and an end point of the lane change path from the traveling lane to the adjacent lane acquired in S202. In addition, the CPU 30 determines coordinates indicating each of a position where the vehicle starts to turn to the traveling lane, a position where the vehicle ends to turn to the traveling lane, and an end point of the lane change path for returning to the traveling lane from the adjacent lane.

In S204, the CPU 30 determines a position where the gradation is started based on the end point of each trajectory image M3. Specifically, the CPU 30 determines the coordinates indicating the position in front of the start point side by a predetermined amount from the coordinates indicating the position of the end point of each lane change path determined in S203 as the position where the gradation is started.

In S205, the CPU 30 displays the plurality of trajectory images M3 on which the gradation is applied. Specifically, the CPU 30 displays the trajectory images M3F and M3B on which the gradation process is performed from the position where the gradation is started determined in S204 to the position indicating the end point of the lane change path on the second display unit 26 (see FIG. 5). Then, the CPU 30 ends the display process.

The vehicle display control device according to the second embodiment detects the instruction to overtake the preceding vehicle, and displays the trajectory image M3B and the trajectory image M3F. Therefore, the sense of security of the occupant can be increased by displaying, in a manner easy to understand, the control range of the driving assistance function related to the lane change for overtaking.

The configuration of the vehicle display control device 10 described in the embodiment is an example and may be changed according to the situation within the scope of not departing from the gist. In addition, the flow of the processing of the program described in the embodiment is also an example, and within a range that does not deviate from the gist, unnecessary steps may be deleted, new steps may be added, or the processing order may be changed.

In addition, each process in which the CPU reads and executes the software (program) in the embodiment may be executed by various processors other than the CPU. Examples of the processor in this case include a programmable logic device (PLD) such as a field-programmable gate array (FPGA) of which circuit configuration can be changed after manufacture, and a dedicated electric circuit that is a processor having a circuit configuration dedicatedly designed to execute specific processing, such as an application specific integrated circuit (ASIC).

In addition, in the embodiment, the aspect has been described in which the program for information processing is stored (installed) in the storage in advance, but the present disclosure is not limited thereto. The program may be provided in a form of being recorded on a recording medium such as a compact disc read only memory (CD-ROM), a digital versatile disc read only memory (DVD-ROM), and a universal serial bus (USB) memory. In addition, the program may be downloaded from an external device via a network. The present disclosure can also be applied to a program and a program product.

What is claimed is:

1. A vehicle display control device comprising:
a detection unit configured to detect, when a driving assistance function of a vehicle is active, an instruction to change a lane of the vehicle; and
a display controller configured to, when the detection unit detects the instruction to change the lane, on a display region provided in the vehicle,
display a path image indicating a lane change path of the vehicle from a traveling lane on which the vehicle travels to a target lane to which a lane change is made, and
display the path image with a mode of the path image changed based on an end point of the path image indicating an end of the lane change path.

2. The vehicle display control device according to claim 1, wherein the display controller is configured to change a display mode of the path image by using, as a start point, a position located a predetermined amount toward a start point side from the end point of the path image.

3. The vehicle display control device according to claim 2, wherein the display controller is configured to display the path image with a gradient from the start point to the end point.

4. The vehicle display control device according to claim 1, wherein:
the detection unit is configured to detect, as the instruction to change the lane, an instruction to overtake a preceding vehicle traveling ahead of the vehicle; and
the display controller is configured to display, as the path image, a first path image indicating a lane change path when a lane change is made from the traveling lane to the target lane at a position rearward of the preceding vehicle, and a second path image indicating a lane change path when a lane change is made from the traveling lane after the lane change to the target lane at a position frontward of the preceding vehicle.
